(19) United States
(12) Patent Application Publication
(10) Pub. No.: US 2026/0312001 A1
(43) Pub. Date: Oct. 8, 2026

(54) Method for Fabricating Anode Electrodes with an Anode Active Material Layer Including 2D Carbon Additives for Lithium-Ion Battery Cells

(71) Applicant: GM GLOBAL TECHNOLOGY OPERATIONS LLC, Detroit, MI (US)

(72) Inventors: Hui HE, Oakland Charter Township, MI (US); Meixian WANG, Troy, MI (US); Niccolo JIMENEZ, Troy, MI (US); Jacob TROGAN, Royal Oak, MI (US); Donghao LIU, Troy, MI (US); Venkataramani ANANDAN, Cumming, GA (US)

(21) Appl. No.: 19/075,969

(22) Filed: Mar. 11, 2025

(51) Int. Cl. H01M 4/1395; B60L 50/64; C09D 5/24; C09D 7/40; C09D 7/61; C09D 7/80; C09D 101/28; C09D 109/06; H01M 4/04; H01M 4/62; H01M 50/46

(52) U.S. Cl. CPC H01M 4/1395; C09D 5/24; C09D 7/61; C09D 7/70; C09D 7/80; C09D 101/286; C09D 109/06; H01M 4/0404; H01M 4/622; H01M 4/625; H01M 50/46; B60L 50/64

(57) ABSTRACT

A method for manufacturing an anode electrode includes a) creating a slurry mixture including carboxymethylcellulose (CMC) and water; b) after a), adding carbon black to the slurry mixture; c) after b), adding a 2 dimensional (2D) carbon additive to the slurry mixture; d) after c), adding a silicon-based active material to the slurry mixture; e) after c), adding graphite to the slurry mixture; and f) after c), adding styrene butadiene rubber (SBR) to the slurry mixture. After e) and before f), adding water to the slurry mixture. The CMC comprises 1% to 10% of a total amount of CMC added to the slurry mixture. After e) and before f), adding 90% to 99% of the total amount of CMC to the slurry mixture. The slurry mixture is used to create the anode electrode.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to a method for manufacturing anode electrodes for lithium-ion battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A method for manufacturing an anode electrode includes a) creating a slurry mixture including carboxymethylcellulose (CMC) and water; b) after a), adding carbon black to the slurry mixture; c) after b), adding a 2 dimensional (2D) carbon additive to the slurry mixture; d) after c), adding a silicon-based active material to the slurry mixture; e) after c), adding graphite to the slurry mixture; and f) after c), adding styrene butadiene rubber (SBR) to the slurry mixture.

In other features, after e) and before f), adding water to the slurry mixture. The CMC comprises 1% to 10% of a total amount of CMC added to the slurry mixture. After e) and before f), adding 90% to 99% of the total amount of CMC to the slurry mixture.

In other features, the method includes creating an anode active material layer using the slurry mixture. The method includes coating the slurry mixture onto an anode current collector to form an anode active material layer of an anode electrode. The method includes drying the slurry mixture in an oven. The method includes forming a battery cell including A of the anode electrode, C cathode electrodes, and S separators where A, C, and S are integers greater than zero.

In other features, the anode active material layer comprises the graphite and the silicon-based active material in a range from 80 wt % to 98 wt %; the carbon black in a range from 0.5 wt % to 1.5 wt %; the 2D carbon additive in a range from 0.05 wt % to 1.5 wt %, the CMC in a range from 0.5 wt % to 2.5 wt %; and the SBR in a range from 1.0 wt % to 4.0 wt %.

In other features, the 2D carbon additive is selected from a group consisting of carbon nanotubes (CNTs) and carbon nanofibers.

A method for manufacturing an anode electrode includes a) creating a slurry mixture including water, graphite, silicon-based active material, a two dimensional (2D) carbon additive, and carbon black; b) after a), adding carboxymethylcellulose (CMC) to the slurry mixture; and c) after b), adding styrene butadiene rubber (SBR) to the slurry mixture. In other features, the method includes creating an anode active material layer using the slurry mixture. The method includes coating the slurry mixture onto an anode current collector to form an anode active material layer of an anode electrode. The method includes drying the slurry mixture in an oven. The method includes forming a battery cell including A of the anode electrode, C cathode electrodes, and S separators, where A, C, and S are integers greater than zero.

In other features, the anode active material layer comprises the graphite and the silicon-based active material in a range from 80 wt % to 98 wt %; the carbon black in a range from 0.5 wt % to 1.5 wt %; the 2D carbon additive in a range from 0.05 wt % to 1.5 wt %; the CMC in a range from 0.5 wt % to 2.5 wt %; and the SBR in a range from 1.0 wt % to 4.0 wt %.

In other features, the 2D carbon additive is selected from a group consisting of carbon nanotubes (CNTs) and carbon nanofibers.

A method for manufacturing an anode electrode includes a) creating a slurry mixture including water, graphite, carboxymethylcellulose (CMC), and carbon black; b) after a), adding silicon-based active material to the slurry mixture; c) after b), a two dimensional (2D) carbon additives to the slurry mixture; and d) after c), adding styrene butadiene rubber (SBR) to the slurry mixture.

In other features, the method includes coating the slurry mixture onto an anode current collector to form an anode active material layer of an anode electrode. The anode active material layer comprises the graphite and the silicon-based active material in a range from 80 wt % to 98 wt %; the carbon black in a range from 0.5 wt % to 1.5 wt %; the 2D carbon additive in a range from 0.05 wt % to 1.5 wt %; the CMC in a range from 0.5 wt % to 2.5 wt %; and the SBR in a range from 1.0 wt % to 4.0 wt %.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of a battery cell including A anode electrodes, C cathode electrodes, and S separators according to the present disclosure;

FIG. 2 is a flowchart of a method for making a slurry during manufacturing of the A anode electrodes;

FIG. 3A is a flowchart of an example of a method for making a slurry during manufacturing of the A anode electrodes according to the present disclosure;

FIG. 3B is a flowchart of a method for manufacturing an anode electrode and a battery cell according to the present disclosure;

FIG. 4 is a flowchart of another example of a method for making a slurry during manufacturing of the A anode electrodes according to the present disclosure;

FIG. 5 is a flowchart of another example of a method for making a slurry during manufacturing of the A anode electrodes according to the present disclosure; and

FIG. 6 is a flowchart of another example of a method for making a slurry during manufacturing of the A anode electrodes according to the present disclosure.

In the drawings, reference numbers may be reused to identify similar and/or identical elements.

### DETAILED DESCRIPTION

While battery cells are described herein in the context of vehicles, the battery cells can be used in other mobile or stationary applications.

Battery cells include cathode electrodes, anode electrodes, and separators. The cathode electrodes include a cathode active material layer arranged on a cathode current collector. The anode electrodes include an anode active material layer arranged on an anode current collector. During manufacturing, the cathode active material layers and/or the anode active material layer may include coatings (including one or more active materials, one or more conductive additives, and/or one or more binder materials) that are applied or cast onto the current collectors.

The coatings corresponding to the active material layers may be formed by mixing a slurry and coating the slurry onto the current collector. To facilitate manufacturing, the slurry should be easy to apply. In some examples, carboxymethylcellulose (CMC) is dissolved in a solvent such as water and used as a thickener and binder when fabricating electrodes for lithium-ion batteries. However, when 2D carbon additives (such as carbon nanotubes (CNTs) or carbon nanofibers) are used in the slurry, interactions may occur with CMC molecules causing low fluidity and/or gelation. Subsequent manufacturing using the slurry leads to non-uniform coatings, delamination, and/or low adhesion of the coating to the anode current collector.

The present disclosure relates to methods for mixing a slurry including 2D carbon additives and CMC that is coated onto a substrate such as an anode current collector to form an anode active material layer of an anode electrode. The slurries described below are stable for over 2 weeks as compared to prior slurries with that experience gelation within 12 hours.

To reduce the strong interaction of the 2D carbon additives with the CMC, the CMC is dissolved in a solvent (such as water) prior to the addition of the 2D carbon additives. As a result, the interaction between the CMC and the 2D carbon additives is mitigated and the stability of the anode slurry is improved. In some examples, the adhesion/peel strength of the anode active material layer on the anode current collector is improved by ~30% (e.g., from ~18 N/m to ~24 N/m) and no electrode delamination is observed.

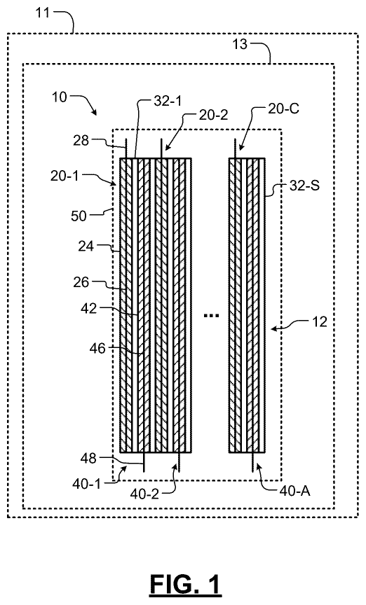

Referring now to FIG. 1, a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the battery cell 10. The battery cell stack 12 is arranged in an enclosure 50 (e.g., a prismatic, cylindrical, or pouch enclosure).

The C cathode electrodes 20-1, 20-2, . . . , and 20-C include a cathode active material layer 24 arranged on one or both sides of a cathode current collector 26. The A anode electrodes 40-1, 40-2, . . . , and 40-A include an anode active material layer 42 arranged one or both sides of an anode current collector 46. During charging/discharging, the A anode electrodes 40 and the C cathode electrodes 20 exchange lithium ions.

In some examples, the cathode active material layers 24 and/or the anode active material layer 44 comprise coatings including one or more active materials, one or more conductive additives, and/or one or more binder materials that are cast or applied onto the current collectors.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

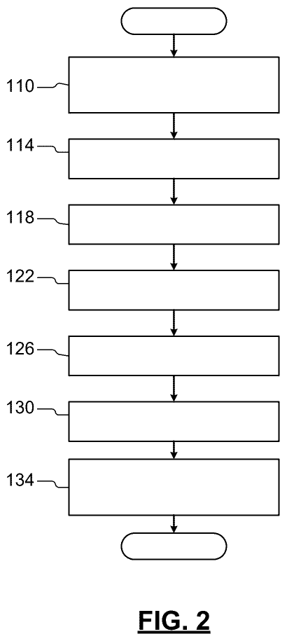

Referring now to FIG. 2, a method for mixing a slurry during manufacturing of the A anode electrodes is shown. At 110, 2D carbon additives (such as carbon nanotubes (CNTs) or carbon nanofibers) and a solvent such as water are mixed. At 114, carboxymethylcellulose (CMC) is added to the mixture. In some examples, solid content at this point is about 1.5%. At 118, carbon black is added to the mixture. In some examples, solid content at this point is about 1.9%. At 122, a silicon-based active material (e.g., silicon, engineered silicon, silicon oxide (SiOₓ), etc.) is added to the mixture. In some examples, solid content at this point is about 7%.

At 126, graphite powder is added to the mixture. In some examples, solid content at this point is about 47%. At 130, a solvent such as water is added to the mixture. In some examples, solid content at this point is about 45%. At 134, styrene butadiene rubber (SBR) is added to the mixture.

After coating and drying, the anode active material layer includes 1.7 wt % CMC, 0.5 wt % carbon black, 0.1 wt % 2D carbon additive (such as single walled CNTs (SWCNTs)), 5.2 wt % silicon-based active material (e.g., SiOₓ), 90 wt % graphite, and 2.5 wt % SBR.

When the 2D carbon additives (such as carbon nanotubes (CNTs) or carbon nanofibers) are used in the slurry, interactions may occur between the 2D carbon additives and the CMC molecules. The interactions cause low fluidity and/or gelation of the slurry (described in FIG. 2) after a relatively short period. Subsequent manufacturing using the slurry leads to non-uniform coatings, delamination, and/or low adhesion of the coating to the anode current collector.

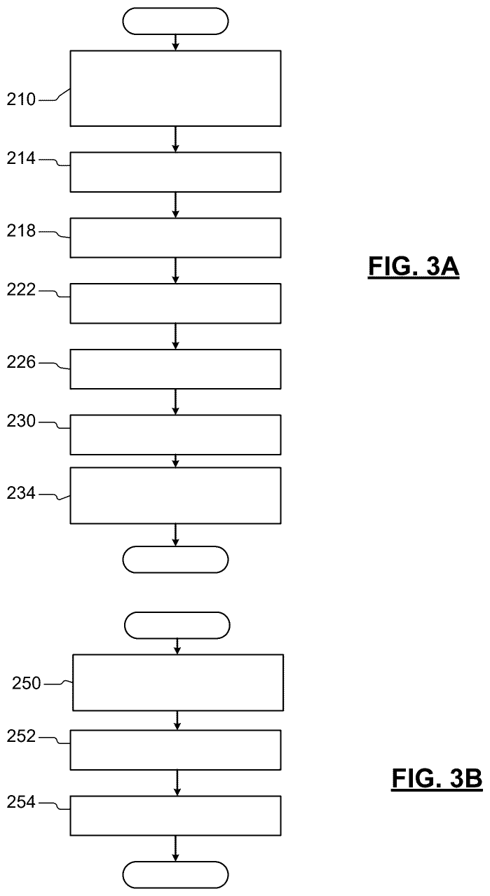

Referring now to FIG. 3A, a method according to the present disclosure for mixing a slurry during manufacturing of the A anode electrodes is shown. At 210, carboxymethyl cellulose (CMC) and a solvent (such as water) are mixed. At 214, carbon black is added to the mixture. In some examples, solid content at this point is about 2%.

At 218, a 2D carbon additive (e.g., CNT and a solvent) is added to the mixture. In some examples, solid content at this point is about 1.6%. At 222, silicon-based active material is added to the mixture. In some examples, solid content at this point is about 6%. At 226, graphite powder is added to the mixture. In some examples, solid content at this point is about 48%. At 230, a solvent (such as water) is added to the mixture. In some examples, solid content at this point is about 45%. At 234, styrene butadiene rubber (SBR) is added to the mixture.

Referring now to FIG. 3B, the slurry is coated onto an anode current collector to form an anode electrode at 250. At 252, the anode electrode is optionally dried in an oven. At 254, a battery cell is formed using the anode electrode.

In some examples, the anode active material layer includes graphite and silicon-based active material in a range from 80 wt % to 98 wt %, carbon black in a range from 0.5 wt % to 1.5 wt %, a 2D carbon additive in a range from 0.05 wt % to 1.5 wt %, CMC in a range from 0.5 wt % to 2.5 wt %, and SBR in a range from 1.0 wt % to 4.0 wt %. In other examples, the anode active material layer includes 1.0 wt % CMC, 0.7 wt % CB, 0.1 wt % single-walled CNT (SWCNT), 5.2 wt % SiOₓ, 90 wt % graphite, and 3 wt % SBR.

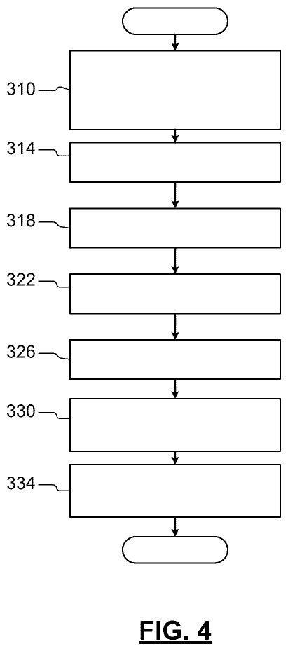

Referring now to FIG. 4, another method for mixing the slurry for the anode active material layer is shown. At 310, a portion of CMC solution (e.g., in a range from 1% to 10% of the total amount of CMC) is mixed with a solvent such as water. At 314, carbon black is added. At 318, a two dimensional (2D) carbon additive is added. At 322, a silicon-based active material is added. At 326, graphite powder is added. As can be appreciated, the ordering of steps 314 to 326 can be varied. At 330, the remaining portion of the CMC (90 % to 99 % of the total amount of CMC) is added to the slurry mixture.

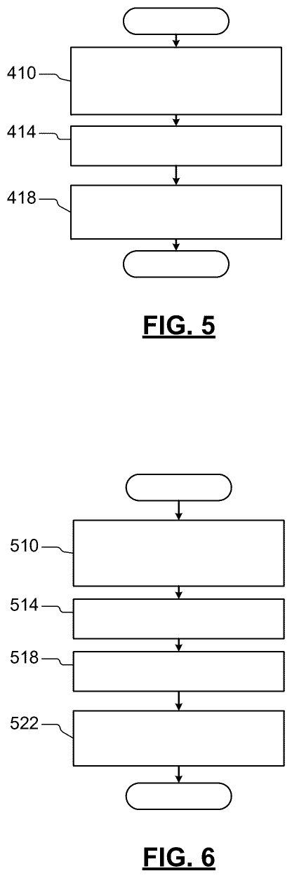

Referring now to FIG. 5, another method for mixing the slurry for the anode active material layer is shown. At 410, a solvent (such as water), graphite, silicon-based active material, a 2D carbon additive, and carbon black are mixed. At 414, CMC is added. At 418, SBR is added.

Referring now to FIG. 6, another method for mixing the slurry for the anode active material layer is shown. At 510, a solvent (such as water), graphite, CMC, and carbon black are mixed. At 514, silicon-based active material is added. At 518, the 2D carbon additive is added. At 522, SBR is added.

As can be appreciated, the slurry mixing methods in FIGS. 4 to 6 also reduce the interaction between the CMC and the 2D carbon additives to improve the stability of the anode slurry and reduce delamination.

The slurry can be used in a roll-to-roll process for manufacturing the anode electrode and/or the battery cell. In some examples, the slurry is coated onto the anode current collector using a doctor blade or slotted die. An oven may be used to heat the anode electrode to dry the slurry.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is

1. A method for manufacturing an anode electrode, comprising:
a) creating a slurry mixture including carboxymethylcellulose (CMC) and water;
b) after a), adding carbon black to the slurry mixture;
c) after b), adding a 2 dimensional (2D) carbon additive to the slurry mixture;
d) after c), adding a silicon-based active material to the slurry mixture;
e) after c), adding graphite to the slurry mixture; and
f) after c), adding styrene butadiene rubber (SBR) to the slurry mixture.

2. The method of claim 1, further comprising after e) and before f), adding water to the slurry mixture.

3. The method of claim 1, wherein the CMC comprises 1% to 10% of a total amount of CMC added to the slurry mixture.

4. The method of claim 3, wherein after e) and before f), adding 90% to 99% of the total amount of CMC to the slurry mixture.

5. The method of claim 1, comprising creating an anode active material layer using the slurry mixture.

6. The method of claim 1, comprising coating the slurry mixture onto an anode current collector to form an anode active material layer of an anode electrode.

7. The method of claim 3, comprising drying the slurry mixture in an oven.

8. The method of claim 6, further comprising forming a battery cell including:
A of the anode electrode;
C cathode electrodes; and
S separators,
where A, C, and S are integers greater than zero.

9. The method of claim 6, wherein the anode active material layer comprises:
the graphite and the silicon-based active material in a range from 80 wt % to wt %;
the carbon black in a range from 0.5 wt % to 1.5 wt %;
the 2D carbon additive in a range from 0.05 wt % to 1.5 wt %;
the CMC in a range from 0.5 wt % to 2.5 wt %; and
the SBR in a range from 1.0 wt % to 4.0 wt %.

10. The method of claim 1, wherein the 2D carbon additive is selected from a group consisting of carbon nanotubes (CNTs) and carbon nanofibers.

11. A method for manufacturing an anode electrode, comprising:
a) creating a slurry mixture including water, graphite, silicon-based active material, a two dimensional (2D) carbon additive, and carbon black;
b) after a), adding carboxymethylcellulose (CMC) to the slurry mixture; and
c) after b), adding styrene butadiene rubber (SBR) to the slurry mixture.

12. The method of claim 11, comprising creating an anode active material layer using the slurry mixture.

13. The method of claim 11, comprising coating the slurry mixture onto an anode current collector to form an anode active material layer of an anode electrode.

14. The method of claim 13, comprising drying the slurry mixture in an oven.

15. The method of claim 13, further comprising forming a battery cell including:
A of the anode electrode;
C cathode electrodes; and
S separators, where A, C, and S are integers greater than zero.

16. The method of claim 13, wherein the anode active material layer comprises:
the graphite and the silicon-based active material in a range from 80 wt % to 98 wt %;
the carbon black in a range from 0.5 wt % to 1.5 wt %;
the 2D carbon additive in a range from 0.05 wt % to 1.5 wt %;
the CMC in a range from 0.5 wt % to 2.5 wt %; and
the SBR in a range from 1.0 wt % to 4.0 wt %.

17. The method of claim 11, wherein the 2D carbon additive is selected from a group consisting of carbon nanotubes (CNTs) and carbon nanofibers.

18. A method for manufacturing an anode electrode, comprising:
a) creating a slurry mixture including water, graphite, carboxymethylcellulose (CMC), and carbon black;
b) after a), adding silicon-based active material to the slurry mixture;
c) after b), a two dimensional (2D) carbon additives to the slurry mixture; and
d) after c), adding styrene butadiene rubber (SBR) to the slurry mixture.

19. The method of claim 18, further comprising coating the slurry mixture onto an anode current collector to form an anode active material layer of an anode electrode.

20. The method of claim 19, wherein the anode active material layer comprises:
the graphite and the silicon-based active material in a range from 80 wt % to wt %;
the carbon black in a range from 0.5 wt % to 1.5 wt %;
the 2D carbon additive in a range from 0.05 wt % to 1.5 wt %;
the CMC in a range from 0.5 wt % to 2.5 wt %; and
the SBR in a range from 1.0 wt % to 4.0 wt %.
